(19) United States
(12) Patent Application Publication
(10) Pub. No.: US 2014/0356279 A1
(43) Pub. Date: Dec. 4, 2014

(54) METHOD FOR MODIFYING TITANIUM SILICON MOLECULAR SIEVES

(71) Applicant: Dalian Unversity of Technology, Dalian, Liaoning (CN)

(72) Inventors: Hongchen Guo, Dalian (CN); Guanghong Liu, Dalian (CN); Ling Liu, Dalian (CN); Ji Su, Dalian (CN)

(73) Assignee: Dalian University of Technology, Dalian, Liaoning (CN)

(21) Appl. No.: 14/355,138

(22) PCT Filed: Mar. 18, 2012
(86) PCT No.: PCT/CN2012/072500

§ 371 Date: Apr. 29, 2014

(30) Foreign Application Priority Data
Oct. 31, 2011 (CN) 201110337609.4
Oct. 31, 2011 (CN) 201110338224.X

(51) Int. Cl. B01J 29/89

(52) U.S. Cl. CPC B01J 29/89; B01J 2229/38; B01J 2229/183; B01J 2229/24
USPC 423/701

(57) ABSTRACT

This invention belongs to the technical field of inorganic chemical synthesis, relating to a modification method for titanium-silicalite zeolite (TS-1). The feature of the invention is pretreating on the TS-1, the TS-1 after pretreatment is modified by the mixture of TPAOH and alkali salts, the alkali salts can be the compounds containing lithium, sodium and potassium element, and then the modification is performed at last. The benefit of the invention is universal capable to modify the TS-1 synthesized by any method, specially the TS-1 with low cost one, the modification can enhance the catalytic performance on both gas and liquid phase epoxidation of propylene.

### FIELD OF THE INVENTION

This invention belongs to the technical field of inorganic chemical synthesis, relating to a modification method for titanium-silicalite zeolite (TS-1).

### BACKGROUND OF THE INVENTION

Titanium-silicalite (TS-1) is a zeolite with transition metal Ti in the framework and MFI framework topology, characterizing good selective oxidation and shape-selectivity. Associated with environmentally-attractive oxidant, aqueous H₂O₂, TS-1 has been widely applied in selective, catalytic oxidation of organic compounds, such as alcohols, phenols, olefins and ethers, etc., especially hydroxylation of phenol, oxidation of cyclohexanone amine and propylene epoxidation have been realized in industrial production.

Since 1981, the synthetic method of TS-1 was firstly published by Macro Taramasso. In the following three decades, hydrothermal synthesis of TS-1 has formed two types through continuous development. One is the adoption of tetrapropylammonium hydroxide (TPAOH) as template to synthesize TS-1 (classic method). The following patents and publications belong to the classic method: U.S. Pat. No. 5,656,252, WO2009077086, CN1167082A, CN 1260241A, CN 1169952A, CN 1239016A, CN1217232A, CN 1239015A, CN1245089A, CN 1247771A, CN1275530A, CN1275529A, CN1294030A, CN1328878A, CN1327947A, CN1418813A, CN1216801C, CN 1488438A, CN 1482062A, CN1634765A, CN 1843626A, CN 1830564A, CN 101134575A, CN101291877A, CN1935651A, CN101190792A, CN101190793A, CN 101434399A, CN101434400A, CN101327934A and CN101696019A, etc.; and Zeolites 12 (1992) 943-950, Zeolites 16 (1996) 184-195, Zeolites 19 (1997) 238-245, Microporous and Mesoporous Materials 22 (1998) 23-31, Microporous and Mesoporous Material 66(2003)143-156 and Chemical Engineering Journal 147 (2009) 316-322, etc. Another one is the use of a relatively low price tetrapropylammonium bromide (TPABr) or other inexpensive template to synthesize TS-1 system (low-cost method). The following patents and publications belong to the low-cost method: U.S. Pat. No. 5,688,484, CN1167010A, CN 1513760A, CN1806918A, CN 101428814A and CN101767036A, etc.; and Material Chemistry and Physics 47 (1997) 225-230, Zeolites 19 (1997) 246-252, Microporous and Mesoporous Materials 12 (1997) 141-148, Catalysis Today 74 (2002) 65-75, Applied Catalysis A 185 (1999) 11 and Chinese Journal of Catalysis 17 (1996) 173-176, etc.

Besides two above-mentioned hydrothermal synthesis, TS-1 can be synthesized by a variety of methods, such as isomorphous substitution, etc. But owing to the longer bond distance of Ti—O than that of Si—O, it is difficult for Ti atom to be introduced into the framework of zeolite. Therefore, no matter which method used in synthesis of TS-1 would form some non-framework titanium species. The existence of non-framework titanium species would generate two negative effects on the production of TS-1. The first one is these non-framework titanium species have no catalytic activity, but would trigger the decomposition of oxidant hydrogen peroxide. Thus during the reaction it would reduce the catalytic performance of TS-1. The second one is the amount of non-framework titanium species is hard to control, which would results in the different catalytic performance of TS-1 from different synthesis batch.

In order to reduce the bad influence of non-framework titanium species, the following patents and publications are about the modification of TS-1.

Patents U.S. Pat. No. 5,367,099, U.S. Pat. No. 5,607,888, U.S. Pat. No. 5,476,823, U.S. Pat. No. 5,365,003, CN101602013A and CN1844321A introduce a silane modified method for zeolite with MFI topology. A representative patent CN101602013A discloses a silane modified method in gas phase for TS-1, in which the silylation agent under nitrogen atmosphere was introduced into the reaction for 0.5-10 h at 50-300° C.

Patents CN1245090A, U.S. Pat. No. 4,794,198, CN1657168A, CN101591024A and CN101417238A introduce an acid treatment for TS-1 to modification. A representative patent CN1657168A discloses an acid treatment for uncalcinated TS-1, in which uncalcinated TS-1 was mixed with acidic solution under room temperature to 200° C., then the regular filtration, wash, dry and calcination were performed.

Patents CN1555923A, CN1268400A, CN101659599A and EP0958861 A1, and publications Catalysis Today 93-95 (2004) 353-357 and Chemical Engineering (China) Vol 39, No 1, P53-57 introduce a salt modification for TS-1. A representative patent CN1268400A discloses a modified method by using aqueous solution of a metal salt or mixtures, in which according to the ratio of metal salt:water:zeolite=0.01-10 g:10-100 ml:1g, TS-1 was added into the aqueous solution of metal salt, and keep the mixture in static state for 6-100 h, then dry it at 30-100° C. by using water bath and further dry it at 110-200° C. in oven for 1-20 h. At last using temperature programmed method to increase temperature from 200 to 800° C. about 1-12 h, the zeolite was calcinated about 2-20 h at this temperature.

The above three modification methods can increase the certain catalytic performance of TS-1. The modification by acid and salt can suppress the negative influence of non-framework of titanium species during the reaction. However, all of these methods cannot essentially eliminate it.

It is reported that inorganic or organic alkalic solution modification of TS-1 can generate holes in TS-1, which is in favor of diffusion of reactants and products.

The following patents introduce modification method of TS-1 by using inorganic or organic alkalic solution.

Patent U.S. Pat. No. 6,475,465B2 and CN1301599A (application date Dec. 24, 1999; application number 99126289.1) both disclose a modification method using organic alkalic solution, in which according to the ratio of organic alkalic solution (such as aliphatic amines, alcohol amines, quaternary ammonium compounds) or mixtures (mol):TS-1(g):water(mol)=(0.005-0.5):100:(5-200), to make them mixed and reacted under 150-180° C. for 2 hours to 3 days. The TS-1 zeolite used here can be the raw or acidic modified TS-1.

Patent CN124090A (application date Aug. 18, 1998, application number 98117503.1) discloses a further modification method using organic alkalic solution for acidic-modified TS-1 sample, in which the mixture of TS-1 sample and acidic solution reacted for 5 min to 6 h under 5-95° C. Then, the acidic-modified TS-1 sample and organic alkalic solution were mixed, and reacted in sealed reactor for 2 h to 8 days under 120-200° C. and autogenous pressure. The organic alkali used here can be aliphatic amines, alcohols amines, quaternary ammonium compounds, etc., or the mixture of these organic alkali.

Patent CN101850985A (application date Mar. 31, 1998, application number 200910131993.5) discloses a method using alkaline solution of pore former to modify TS-1 sample. In this method, TS-1 sample was added into alkaline solution of pore former, the mixture with the ratio of TS-1:pore former:alkali:water=100:(0.001-5):(0.005-5):(200-10000) was attained. Then the mixture reacted for 2-360 h under 80-200 ° C. and autogenous pressure. The pore former can be sucrose, starch, furfural, phenol, benzothiophene, dibenzothiophene, naphthyl, quinoline, carbazole, indole, polypropylene, polyethylene glycol, polystyrene, polyvinyl chloride, polyethylene and the mixtures or derivatives of these compounds. The alkaline source can be divided into organic or inorganic alkali, in which organic alkali can be urea, quaternary ammonium hydroxides compounds, aliphatic amines, alcohols amines and the mixture of these compounds; inorganic alkali can be ammonia, sodium hydroxide, potassium hydroxide, barium hydroxide and the mixture of these compounds.

Patent CN101537372A, CN101618338A, CN101618339A, CN101623653A, 101658791A, CN101658798A, CN1016646696A, CN101665256A and CN101670298A disclose a modification method for TS-1 using alkaline solution involving noble metal. In this method, the mixture of TS-1, aqueous solution of silicon, noble metal source, protective agent and alkaline source was hydrothermally reacted in sealed reactor, and recycled the products. The noble metal source can be the oxides, halides, carbonates, nitrates, ammonium salts and hydroxides of Ru, Rh, Pd, Re, Os, Ir, Pt, Ag and Au, or other compounds of these metal. Protective agent can be glucose, cyclodextrin, polybenzimidazole, polypropylene, polyethylene glycol, polystyrene, polyvinyl chloride and polyethylene, etc. Surface active agents include cationic surfactants, anionic surfactants and nonionic surfactants. The alkaline source can be divided into organic or inorganic alkali, in which organic alkali can be urea, quaternary ammonium hydroxides compounds, aliphatic amines, alcohols amines and the mixture of these compounds; inorganic alkali can be ammonia, sodium hydroxide, potassium hydroxide, barium hydroxide and the mixture of these compounds.

Patent CN1260241 (application date Apr. 10, 1998, application number 98101357.0) discloses a modification method using alkaline hydrolysis of titanium source solution. In this method, according to the ratio of hydrolysis of titanium source solution:TS-1 sample=200-1500:1, the mixture was crystallized in reactor for 1-8 days under 120-180° C., then TS-1 with extra Ti was obtained after filtration, wash and dry. The alkaline solution can be quaternary ammonium alkali compounds, aliphatic amines and alcohols amines, or the mixture of these compounds.

Patent CN1421389A (application date Nov. 29, 2001, application number 01140182.6) disclose a modification method using alkaline solution of silicon. In this method, according to the ratio of aqueous solution of silicon:TS=70-1500:1, the mixture was reacted in reactor for 0.1-150 h under 120-180° C., then silicon-modified TS-1 was obtained after filtration, wash and dry. The alkaline solution can be quaternary ammonium alkali compounds, aliphatic amines and alcohols amines, or the mixture of these compounds.

Patent CN101850986A (application date Mar. 31, 2009, application number 200910131992.0) disclose a modification method using mixed alkaline solution (organic and inorganic). In this method, according to the ratio of TS-1:inorganic alkalin:organic alkalin:water=100g:(0.005-5 g):(0.01-10 mol):(200-10000 mol), the mixture was reacted for 2-360 h under 80-200° C. and autogenous pressure. Organic alkali can be urea, quaternary ammonium hydroxides compounds, aliphatic amines, alcohols amines and the mixture of these compounds; inorganic alkali can be ammonia, sodium hydroxide, potassium hydroxide, barium hydroxide and the mixture of these compounds. And the ratio of organic and inorganic alkali is 1-50:1.

The following publications also report a modification method for TS-1 by using organic alkaline solution.

Microporous and Mesoporous Materials 102 (2007) 80-85 reported a modification method by using aqueous solution of tetrapropylammonium hydroxide. In this method, TS-1 sample (1g) was added into the mixed aqueous solution of 4.17 ml TPAOH (1M) and 3.32 ml water, then crystallized under static condition and 170° C. for 24 h. After filtration, wash and dry, modified TS-1 was calcinated for 16 h under 520° C.

The mater dissertation by Baoji Zhang titled “The Study About Synthesis of TS-1, Alkali Modification, Extrudation and Catalytic oxidation of cyclohexane” reported a modification method by using organic alkaline solution. In this method, the organic alkaline solution included TPAOH, ethanolamine, ammonia, hexamethylene tetramine, tetraethyl ammonium hydroxide, the mixture of ammonia and TPABr, the mixture of tetraethyl ammonium hydroxide and TPABr. It is worth mentioning that the catalytic performance has been improved more than twice by using TPAOH. And the catalytic performance has been nearly doubled by using the mixture of ammonia and TPABr, the mixture of tetraethyl ammonium hydroxide and TPABr.

The mater dissertation by Janbo Yin titled “The Optimization of Styrene Epoxidation with H₂O₂ on TS-1” reported a modification method for TS-1 by using organic, inorganic alkaline solution and alkaline salts. In this method, TS-1 sample was added into the solution of organic, inorganic and salts to react for 24 h. Then modified TS-1 was obtained after filtration, wash, dry under 100° C. and calcination for 6 h under 540° C. The salt includes Na₂CO₃, sodium citrate, sodium acetate and NaNO₃. The organic alkali includes TPAOH, tetraethyl ammonium bromide (salt), triethanolamine, propylamine and urea. It is worth mentioning that the modification using inorganic alkaline solution and salt was not good as that by using organic alkaline solution. The only effect of salt during the modification was the cation as inhibitors of acidity.

Many public literatures have reported a modification by using organic alkaline solution, such as many mater dissertations “Synthesis and Modification of Titanium Silicalite-1 and its Performance in Ammoxidation of Methyl Ethyl Ketone” by Lizhen Xia, “Characterization of Titanium Silicalite-1 modified by organic base and its performance in Ammoxidation of Methyl Ethyl Ketone” by Peng Li, “Oxidative Desulfurization of Sulfide over Titanium Silicalite” by Lixia Zhao, “The characters and catalysis activities of micro-TS-1 modified by several kind of Alkali” by Jingbo Mao, “Effect Factors in Synthesis Process of TS-1 Zeolite” by Yang Liu, “The Effect of Modification on TS-1 and Gas-Phase Epoxidation of Propylene” by Guanghong Liu, “The synthesis of TS-1 and catalytic performance in propylene epoxidation” by Xinxu Liu, and some references, such as Acta Petrolei Sinica 2008 24 (1) 57-62, Journal of Fuel Chemistry and Technology 2008 36 (4) 484-488. In this method, alkaline solution includes TMAOH, TEAOH, TPAOH (best modification effect), TBAOH, NaOH, NH₃ and Na₂CO₃, etc.

To sum up, the effect of inorganic alkaline solution for TS-1 treatment is to dissolve the framework of TS-1, and then internal cavities in TS-1 were generated. General organic bases such as aliphatic amines and alkanolamines have similar performance as inorganic alkali, but quaternary ammonium bases not only can dissolve the framework of zeolite, but also can make dissolved silicon titanium species re-crystallized resulting in some non-framework titanium into framework of zeolite. It is generally thought the effect of treatment of TPAOH for TS-1 is better than that of other quaternary ammonium bases. However, the TPAOH treatment has application issue. Besides TS-1 sample synthesized by classic methods and some low-cost methods, not all TS-1 sample can be modified well. The main reasons which cause this phenomenon is big crystal and many amorphous non-framework titanium species in low-cost synthesized TS-1 sample. These two reasons would result in big diffusion resistance, because of longer diffusion path for dissolved titanium species during modification. Furthermore, titanium species in solution is favorable to form TiO₂ (anatase). Therefore, the activity of many low-cost synthesized TS-1 after TPAOH modification is not significant improved.

### SUMMARY OF THE INVENTION

The invention is to solve the modification of TS-1 based on the mixture of TPAOH and inorganic alkali, the catalyst after modification showed better catalytic performance on both gas or liquid phase epoxidation of propylene than before. The key of the patent is the introduction of alkali salts during the TPAOH modified TS-1 processing. It was found that the limitation of the TS-1 modification can be solved by the use of TPAOH and alkali salts, it means that the TS-1 synthesized by classic and low cost method can be modified by TPAOH and alkali salts mixture. Because the cation of alkali salts and the titanium acid radical ion can form the monodisperse or oligomeric ion pairs, the ion pairs could avoid the condensation from titanium acid radical ions to anatase TiO₂. The ion pairs was important to the modification of TS-1 synthesized by low cost method, under the low cost method, the micro-sized TS-1 particles was obtained, the attact of OH— ions to the framework resulted in the Si and Ti spieces brush off from the inner defective sites of the crystal, the strong interaction between alkali salts and the Ti spieces avoid the polymerization of TiO2, and led to much more Ti spieces shift from the crystal of micro-sized TS-1 synthesized by low cost method, and reform back into the framework. It was found that the Ti—O—Ti framework structure (Raman peak at 850 cm-1) was obtained after the modification of TPAOH and alkali salts, Ti—O—Ti framework could transport to high active Ti spiece during the reaction, therefore the modification of TPAOH and alkali salts was benefit to promote the activity of TS-1. The result indicated that alkality (OH⁻ concentration), four propyl cation (TPA⁺) and alkali metal cations (such as Na⁺, K⁺ etc.) are the important factors during the modified processing. The factors mentioned above could supply by TPAOH and alkali salts or four propyl quaternary ammonium salt and inorganic alkali, because the ionized sepieces of both two mixture aqueous solution are the same to each other, and the cost of four propyl quaternary ammonium salt is much lower than the TPAOH, the replacement of TPAOH and alkali salts by four propyl quaternary ammonium salt and inorganic alkali can reduce the cost greatly. The modification of TS-1 with different method synthesized by four propyl quaternary ammonium salt and inorganic alkali can produce the high active Ti—O—Ti structure, the treatment can enhance the catalytic property of TS-1 obviously.

### DETAILED DESCRIPTION OF THE INVENTION

### Introduction

First step, the pretreatment of TS-1. Pretreatment can remove the template under high temperature in air or protective gas. During the pretreatment, the calcination temperature is normally between 300 to 700° C., prior between 400-600° C.; the calcination time is normally between 30 min to 200 h, prior between 3 to 24 h. The aim of calcination is to remove the organic template exist in the channel, the blockage of the template in the channels could reject the decomposition and the recrystallization of alkaline liquor to the TS-1. The TS-1 zeolite could obtained from the public references and patents that mentioned in the technology background by hydrothermal synthesis. Any of the engineer who is familiar with this field could prepared the TS-1 that used in this innovation.

Second step, the modification of TS-1 after pretreatment is by the mixture of TPAOH and alkali salts. The alkali salts mentioned above could be Li, Na and K salts and their mixture. During the modification, when the ratio of TS-1 to TPAOH to alkali salts to H₂O is setted at TS-1/g:TPAOH/mol:salts/g:H₂O/g=50:0.005-50:0.05-5:200-2000, the best catalytic activity can be achieved after modification. The treatment is performed in the reactor under the temperature between 50 to 250° C. and the time between 2 h to 10 days. The modification can carry out under stirring or static state, the stirring rate can keep the concentration and temperature uniform of the liquid is better.

Third step, the aftertreatment of TS-1 after the modification. The aftertreatment include separation, wash, dry and calcination. Wash is carried out with deionized water utill the ph value of filter liquor should between 7 to 9; Dry can performed in air or protective gas, the temperature is between 60 to 200° C., the time is between 1 to 100 h, 3 to 10 h is preferred. calcination can performed in air or protective gas, the temperature is between 200 to 500° C., the time is between 30 min to 100 h. The remain alkali cations would affect the modification result when the ph value of filter liquor is above 9. TS-1 show bad stability and activity when the TS-1 after modification is uncalcined or calcined out the temperature between 200 to 500° C.

The benefit of the invention is universally capable to modify the TS-1 synthesized by any method, specially the TS-1 with low cost method, the modification can enhance the catalytic performance on both gas or liquid phase epoxidation of propylene, the more important thing is the use of quaternary ammonium salt and inorganic alkali can decrease the cost of TS-1 modification greatly.

### EXAMPLES

Hereinafter, the present invention will further specifically be described with respect to examples, but the present invention is not limited to these examples.

### Comparative Example 1

This compared example introduce the modification of TS-1 with classic method by the mixed alkali liquor of TPAOH and alkalic metal salts.

First step, the TS-1 synthesized by classic method (U.S. Pat. No. 4,410,501) was calcined at 540° C. in air for 6 h to remove the template.

Second step, the mixture of classic TS-1, salt, TPAOH and water with a ration is TS-1/g:salt/mol:TPAOH/mol:H₂=50:0.035:1.4:500. Then the mixture was modified under 170° C. for 24 h in a reactor statically.

Third step, the TS-1 obtained from second step was performed by filter, wash, dry and at last calcined at 390° C. for 6 h.

The TS-1 before and after modification catalytic performance of gas phase epoxidation of propylene was carried out as the open literature (Chinese Journal of catalysis, 31 (2010) 1195-1199) description. Reaction conditions: the flow of H₂, O₂ and propylene is 170 ml/min, 8 ml/min and 18 ml/min (the molar ratio of H₂ to O₂ to C₃=170/8/18), the amount of TS-1 is 0.8 g (WHSVC₃=2.53 h⁻¹), the temperature is 110° C. The main evaluation parameters of gas-solid phase epoxidation of propylene are the conversion of C₃H₆ and the selectivity of PO. The reaction results showed that the conversion of C₃H₆ and the selectivity of PO is 4.4% and 91.2 respectively over the TS-1 before modification, 8.8% and 99.6% over the TS-1 after modification.

### Comparative Example 2

Repeat the compared example 1, but the TS-1 sample with big crystal modified was synthesized by the open literature of Appl. Catal. A, 185, (1999) 11 under low cost method. The epoxidation results displayed that the conversion of C₃H₆ and the selectivity of PO is 4.5% and 78.4 respectively over the TS-1 before modification, 8.9% and 99.2% over the TS-1 after modification.

### Comparative Example 3

Repeat the compared example 1, the liquid phase epoxidation of propylene was carried out under the reaction conditions as follows: a 400 ml uncontinuous stainless-steel high pressure reactor; the catalyst was 0.2 g, the methanol was 30 ml and 30 wt % H₂O₂ was 2 ml; the propylene was introduced under stirring and the C₃H₆ was charged at constant pressure (0.4 Mpa); reaction temperature was 50° C.; reaction time was 60 min; the conversion of H₂O₂ was measured by the iodometric titration. The selectivity of PO and utilization of H₂O₂ was analyzed on a chromatography. The TS-1 before modification showed 76.3% of H₂O₂ conversion, 78.8% of PO selectivity and 78.2% utilization of H₂O₂; 89.3% of H₂O₂ conversion, 95.8% of PO selectivity and 93.2% utilization of H₂O₂ over the TS-1 after modification.

### Example 1

First step, the TS-1 sample with big crystal modified was synthesized by the open literature of Appl. Catal. A, 185, (1999) 11 under low cost method, and then calcined at 540° C. in air for 6 h to remove the template.

Second step, the mixture of cheap TS-1, four propyl quaternary ammonium salt, sodium hydrate and water with a ratio was TS-1/g:TPA⁺/mol:salt/g:H₂=50:0.035:1.4:500. Then the mixture was modified under 170° C. for 24 h in a reactor statically.

Third step, the TS-1 obtained from second step was filtered by deioned water until ph about 7, then dried in air at 110° C. for 12 h and calcined at 390° C. for 6 h.

The TS-1 before and after modification catalytic performance of gas phase epoxidation of propylene was carried out as the public literature (Chinese Journal of catalysis, 31 (2010) 1195-1199) description. Reaction conditions: the flow of H₂, O₂ and propylene is 170 ml/min, 8 ml/min and 18 ml/min (the molar ratio of H₂ to O₂ to C₃=170/8/18), the amount of TS-1 is 0.8 g (WHSVC₃=2.53 h⁻¹), the temperature is 110° C. The main evaluation parameters of gas-solid phase epoxidation of propylene are the conversion of C₃H₆ and the selectivity of PO. The reaction results showed that the conversion of C₃H₆ and the selectivity of PO is 4.5% and 78.4% respectively over the TS-1 before modification, 8.9% and 99.8% over the TS-1 after modification.

### Example 2

Repeated the example 1, but the TS-1 was synthesized under classic system (U.S. Pat. No. 4,410,501). The results showed that the conversion of C₃H₆ and the selectivity of PO is 4.4% and 91.2% respectively over the TS-1 before modification, 8.8% and 99.6% over the TS-1 after modification.

### Example 3

Repeated the example 1, the liquid phase epoxidation of propylene was carried out under the reaction conditions as follows: a 400 ml uncontinuous stainless-steel high pressure reactor; the catalyst is 0.2 g, the methanol is 30 ml and 30 wt % H₂O₂ is 2 ml; the propylene is introduced under stirring and the C₃H₆ is charged at constant pressure (0.4 Mpa); reaction temperature is 50° C.; reaction time is 60 min; the conversion of H₂O₂ is measured by the iodometric titration; the selectivity of PO and utilization of H₂O₂ is analyzed on a chromatography. The TS-1 before modification showed 72.7% of H₂O₂ conversion, 73.4% of PO selectivity and 68.8% utilization of H₂O₂; 87.4% of H₂O₂ conversion, 92.6% of PO selectivity and 92.7% utilization of H₂O₂ over the TS-1 after modification.

### Example 4

Repeated the example 1, the tetrapropylammonium bromide was replaced by equal tetrapropyl ammonium fluoride, tetrapropylammonium chloride and tetrapropylammonium iodide. The epoxidation results were as follows: the TS-1 before modification show 4.5% of C₃H₆ conversion and 78.4% of PO selectivity; 8.6% of C₃H₆ conversion and 99.1% of PO selectivity over TS-1 after tetrapropyl ammonium fluoride modification; 8.7% of C₃H₆ conversion and 99.5% of PO selectivity over TS-1 after tetrapropylammonium chloride modification; 8.8% of C₃H₆ conversion and 99.4% of PO selectivity over TS-1 after tetrapropylammonium iodide modification.

### Example 5

Repeated the example 1, the tetrapropylammonium bromide was replaced equally by tetrapropyl ammonium fluoride and tetrapropylammonium chloride (ratio=1:1) or tetrapropylammonium bromide and tetrapropylammonium iodide (ratio=1:4) mixture. The epoxidation results were as follows: the TS-1 before modification shows 4.5% of C₃H₆ conversion and 78.4% of PO selectivity; 8.8% of C₃H₆ conversion and 99.5% of PO selectivity over TS-1 after tetrapropyl ammonium fluoride and tetrapropylammonium chloride (ratio=1:1) modification; 8.6% 1 of C₃H₆ conversion and 99.6% of PO selectivity over TS-1 after tetrapropylammonium bromide and tetrapropylammonium iodide (ratio=1:4) modification.

### Example 6

Repeated the example 1, change the amount of TPAOH, so that the TS-1, TPAOH, sodium bromide and water were mixed with a ratio was TS-1/g:TPAOH/mol:salt/g:H₂=50:0.035:1.4:500 and 50:50:1.4:500. The epoxidation results were as follows: the TS-1 before modification shows 4.5% of C₃H₆ conversion and 78.4% of PO selectivity; 6.2% of C₃H₆ conversion and 83.1% of PO selectivity over the TS-1 modified with the former ratio; 5.6% of C₃H₆ conversion and 82.3% of PO selectivity over the TS-1 modified with the later ratio;

### Example 7

Repeated the example 1, change the amount of sodium bromide, so that the TS-1, TPAOH, sodium bromide and water were mixed with the ratio is TS-1/g:TPAOH/mol:salt/g:H₂O=50:0.005:1.4:500 and 50:50:1.5:500. The epoxidation results were as follows: the TS-1 before modification shows 4.5% of C₃H₆ conversion and 78.4% of PO selectivity; 6.2% of C₃H₆ conversion and 83.1% of PO selectivity over the TS-1 modified with the former ratio; 5.6% of C₃H₆ conversion and 82.3% of PO selectivity over the TS-1 modified with the later ratio;

### Example 8

Repeated the example 1, change the amount of H₂O, so that the TS-1, TPAOH, sodium bromide and water were mixed with the ratio was TS-1/g:TPAOH/mol:salt/g:H2O=50:0.035:1.4:200 and 50:0.035:1.4:2000. The epoxidation results were as follows: the TS-1 before modification shows 4.5% of C₃H₆ conversion and 78.4% of PO selectivity; 7.5% of C₃H₆ conversion and 96.5% of PO selectivity over the TS-1 modified with the former ratio; 6.6% of C₃H₆ conversion and 91.4% of PO selectivity over the TS-1 modified with the later ratio.

### Example 9

Repeated the example 1, the reaction was carried out under stirring. TS-1 before modification showed 4.5% of C₃H₆ conversion and 78.4% of PO selectivity; TS-1 after modification under agitation displayed 8.7% of C₃H₆ conversion and 99.1% of PO selectivity.

### Example 10

Repeated the example 1, the reaction was performed over the TS-1 with pretreated temperature at 300° C., 400° C., 600° C. and 700° C. TS-1 before modification showed 4.5% of C₃H₆ conversion and 78.4% of PO selectivity; TS-1 pretreated at 300° C. displayed 6.4% of C₃H₆ conversion and 91.3% of PO selectivity; TS-1 pretreated at 400° C. displayed 7.7% of C₃H₆ conversion and 94.5% of PO selectivity; TS-1 pretreated at 600° C. displayed 7.6% of C₃H₆ conversion and 93.7% of PO selectivity; TS-1 pretreated at 700° C. displayed 6.2% of C₃H₆ conversion and 91.4% of PO selectivity.

### Example 11

Repeated the example 1, the TS-1 pretreated time was change to 30 min, 3 h, 24 h and 200 h. TS-1 before modification showed 4.5% of C₃H₆ conversion and 78.4% of PO selectivity; TS-1 pretreated for 30 min displayed 5.4% of C₃H₆ conversion and 89.7% of PO selectivity; TS-1 pretreated for 3 h displayed 7.2% of C₃H₆ conversion and 94.5% of PO selectivity; TS-1 pretreated for 24 h displayed 8.2% of C₃H₆ conversion and 95.5% of PO selectivity; TS-1 pretreated for 200 h displayed 6.2% of C₃H₆ conversion and 93.5% of PO selectivity.

### Example 12

Repeated the example 1, the TS-1 modified temperature was change to 50° C. and 250° C. TS-1 before modification showed 4.5% of C₃H₆ conversion and 78.4% of PO selectivity; TS-1 modified at 50° C. displayed 6.6% of C₃H₆ conversion and 91.7% of PO selectivity; TS-1 modified at 250° C. displayed 6.0% of C₃H₆ conversion and 92.1% of PO selectivity.

### Example 13

Repeated the example 1, the TS-1 modified time was change to 2 h and 10 days. TS-1 before modification showed 4.5% of C₃H₆ conversion and 78.4% of PO selectivity; TS-1 modified for 2 h displayed 5.0% of C₃H₆ conversion and 89.7% of PO selectivity; TS-1 modified for 10 d displayed 8.2% of C₃H₆ conversion and 95.5% of PO selectivity.

### Example 14

Repeated the example 1, the ph value in the step 3 was set as 9. TS-1 before modification showed 4.5% of C₃H₆ conversion and 78.4% of PO selectivity; TS-1 after modification displayed 5.3% of C₃H₆ conversion and 98.7% of PO selectivity.

### Example 15

Repeated the example 1, the dry temperature in the step 3 was changed to 60° C. and 500° C. TS-1 before modification showed 4.5% of C₃H₆ conversion and 78.4% of PO selectivity; TS-1 dried at 60° C. displayed 8.4% of C₃H₆ conversion and 96.7% of PO selectivity; TS-1 dried at 250° C. displayed 4.9% of C₃H₆ conversion and 95.3% of PO selectivity.

### Example 16

Repeated the example 1, the dry time in the step 3 was changed to 1 h and 100 h. TS-1 before modification showed 4.5% of C₃H₆ conversion and 78.4% of PO selectivity; TS-1 dried for 1 h displayed 8.1% of C₃H₆ conversion and 93.6% of PO selectivity; TS-1 dried for 100 h displayed 8.3% of C₃H₆ conversion and 96.3% of PO selectivity.

### Example 17

Repeated the example 1, the calcination temperature in the step 3 was changed to 200° C. and 500° C. TS-1 before modification showed 4.5% of C₃H₆ conversion and 78.4% of PO selectivity; TS-1 calcined at 200° C. displayed 9.2% of C₃H₆ conversion and 99.5% of PO selectivity; TS-1 calcined at 500° C. displayed 5.0% of C₃H₆ conversion and 97.3% of PO selectivity.

### Example 18

Repeated the example 1, the calcination time in the step 3 was changed to 300 min and 100 h. TS-1 before modification showed 4.5% of C₃H₆ conversion and 78.4% of PO selectivity; TS-1 calcined for 300 min displayed 8.5% of C₃H₆ conversion and 96.8% of PO selectivity; TS-1 calcined for 100 h displayed 7.8% of C₃H₆ conversion and 97.5% of PO selectivity.

We claim:

1. A modification method of TS-1 by TPAOH and inorganic alkali include some steps as follows:
First step, the pretreatment of TS-1. The calcination temperature is between 300 to 700° C., the calcination time is between 30 min to 200 h;
second step, the modification of TS-1 after pretreatment is by the mixture of TPAOH and alkali salts. The alkali salts mentioned above could be Li, Na and K salts and their mixture, the treatment is performed in the reactor under the temperature between 50 to 250° C. and the time between 2 h to 10 days;
third step, the aftertreatment of TS-1 after the modification. The aftertreatment include separation, wash, dry and calcinations.

2. Base on the method described in claim 1, the calcination temperature is seted between 400 to 600° C., the calcination time is between 3 h to 24 h during the pretreatment.

3. Base on the method described in claim 1, the ratio of TS-1 to TPAOH to salts to H₂O is setted at TS-1/g:TPAOH/mol:salts/g:H₂O/g=50:0.005-50:0.05-5:200-2000 during the modification.

4. Base on the method described in claim 1, the ph value of filter liquor should between 7 to 9 during the aftertreatment.

5. Base on the method described in claim 1, the calcination should performed after dry, the temperature is between 200 to 500° C., the time is between 30 min to 100 h.
